(19) United States
(12) Patent Application Publication
(10) Pub. No.: US 2015/0013515 A1
(43) Pub. Date: Jan. 15, 2015

(54) GUARD, RIVING KNIFE, AND ANTI-KICKBACK PAWL ASSEMBLY

(71) Applicant: Power Tool Institute, Cleveland, OH (US)

(72) Inventors: David V. Keller, Jackson, TN (US); Mark D. Hickok, Waukesha, WI (US); Peter L. Domeny, Peachtree City, GA (US); Thornton H. Gogoll, III, Baltimore, MD (US); David G. Peot, Easley, SC (US); Stan M. Rodrigues, Pleasanton, CA (US); Christopher S. Tennant, Clemson, SC (US)

(21) Appl. No.: 14/499,872

(22) Filed: Sep. 29, 2014

Related U.S. Application Data
(63) Continuation of application No. 12/054,898, filed on Mar. 25, 2008, now abandoned.

(51) Int. Cl. B27G 19/08

(52) U.S. Cl. CPC B27G 19/08
USPC 83/102.1

(57) ABSTRACT

In various embodiments, a saw accessory assembly can be configured to be attached to a saw. In at least one embodiment, the assembly can include a first component and a second component, wherein at least one of the first and second components can include a visual guide configured to assist an operator in assembling the first and second components. In other various embodiments, at least one of the first and second components can include a visual guide configured to assist the operator in adjusting the first and second components in a predetermined sequence.

### BACKGROUND

i. Field of the Invention

The present invention generally relates to saws and, more particularly, to saw accessories mounted to saws.

ii. Description of the Related Art

Saws often include safety devices, or saw accessories, that can protect an operator from being injured while using the saw. Table saws, for example, can include saw accessories such as a blade guard, a riving knife, a throat plate, and/or one or more anti-kickback pawls. A blade guard can be disposed over and/or around a saw blade to reduce the likelihood that the operator may accidentally touch the saw blade. A riving knife, or splitter, may be mounted to the saw in alignment with the blade such that the riving knife can be positioned within and/or engage a slot, or kerf, in a workpiece created by the blade. As a result, the riving knife can prevent, or at least inhibit, portions of the workpiece from pinching onto the blade and, as a result, preventing the workpiece from kicking back or lifting upwards toward the operator. In various embodiments, one or more anti-kickback pawls can be attached to the blade guard and/or riving knife, for example, in such a manner as to prevent, or at least inhibit, the workpiece from lifting upwardly by forcing the workpiece against a work surface of the saw. In at least one embodiment, a throat plate can be configured to surround the saw blade and cover a blade opening in the work surface thereby preventing the workpiece from being forced into the blade opening by the rotational motion of the saw blade.

In various embodiments, a riving knife can be mounted to a saw underneath the work surface thereof via fasteners and/or bolts, for example. In at least one embodiment, an operator can remove the throat plate surrounding the saw blade to access the fasteners or bolts and make adjustments to, or swap, the riving knife. In various embodiments, the anti-kickback pawls and blade guard can be mounted to a portion of the riving knife and can extend above the work surface of the saw. In at least one such embodiment, the riving knife and/or other saw accessories may include several components which may need to be assembled together and/or otherwise adjusted. In some instances, the sequence in which the accessories are assembled and/or adjusted can be crucial to their proper operation. As a result of the above, the operator of the saw may, at times, use the saw without installing the saw accessories or without adjusting the saw accessories properly because of the complicated nature of the assembly and adjustment of such components. What is needed is an improvement over the foregoing.

### SUMMARY

In at least one form of the invention, a saw accessory assembly can be configured to be attached to a saw. In various embodiments, the assembly can include a first component and a second component, wherein at least one of the first and second components can include a visual guide configured to assist an operator in assembling the first and second components to each other and/or to the saw. In various embodiments, such visual guides can include one or more colors, including shades and/or intensities thereof, surface textures, indicium, profiles, and/or outlines. In such embodiments, the visual guides can indicate to the operator the order and manner in which the saw assembly can, or should, be assembled. Similarly, the saw accessories can include visual guides which can assist an operator in making adjustments to the saw accessory assembly. In at least one such embodiment, the visual guides can indicate to the operator the order in which the saw accessories can, or should, be adjusted.

### BRIEF DESCRIPTION OF THE DRAWINGS

The above-mentioned and other features and advantages of this invention, and the manner of attaining them, will become more apparent and the invention itself will be better understood by reference to the following description of embodiments of the invention taken in conjunction with the accompanying drawings, wherein:

FIG. 1 is a perspective view of a saw including a plurality of saw accessories attached thereto in accordance with one non-limiting embodiment of the present invention;

FIG. 2 is a perspective view of the plurality of saw accessories of FIG. 1;

FIG. 3 is a perspective view of the plurality of saw accessories of FIG. 2 positioned in a tilted configuration with respect to a work surface of the saw;

FIG. 4 is an exploded perspective view of the plurality of saw accessories of FIG. 2 where the saw accessories include visual guides in accordance with one non-limiting embodiment of the present invention;

FIG. 5 is another exploded view of the plurality of the saw accessories of FIG. 4;

FIG. 6 is an exploded perspective view of the plurality of saw accessories of FIG. 2 where the saw accessories include visual adjustment guides in accordance with one non-limiting embodiment of the present invention; and

FIG. 7 is another exploded view of the plurality of saw accessories of FIG. 6.

Corresponding reference characters indicate corresponding parts throughout the several views. The exemplifications set out herein illustrate various embodiments of the invention, in one form, and such exemplifications are not to be construed as limiting the scope of the invention in any manner.

### DETAILED DESCRIPTION

Certain exemplary embodiments will now be described to provide an overall understanding of the principles of the structure, function, manufacture, and use of the devices and methods disclosed herein. One or more examples of these embodiments are illustrated in the accompanying drawings. Those of ordinary skill in the art will understand that the devices and methods specifically described herein and illustrated in the accompanying drawings are non-limiting exemplary embodiments and that the scope of the various embodiments of the present invention is defined solely by the claims. The features illustrated or described in connection with one exemplary embodiment may be combined with the features of other embodiments. Such modifications and variations are intended to be included within the scope of the present invention.

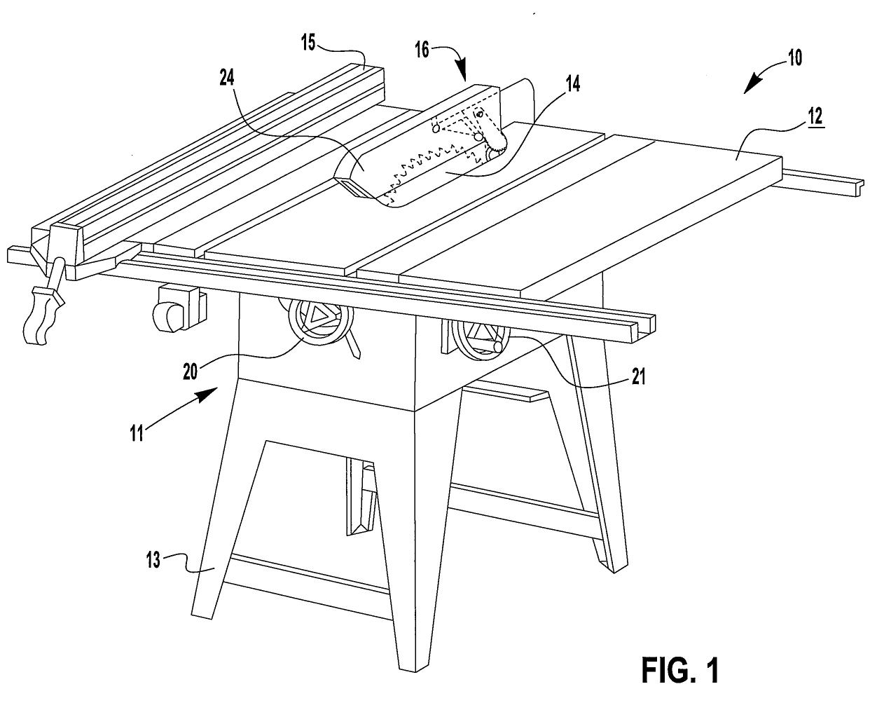

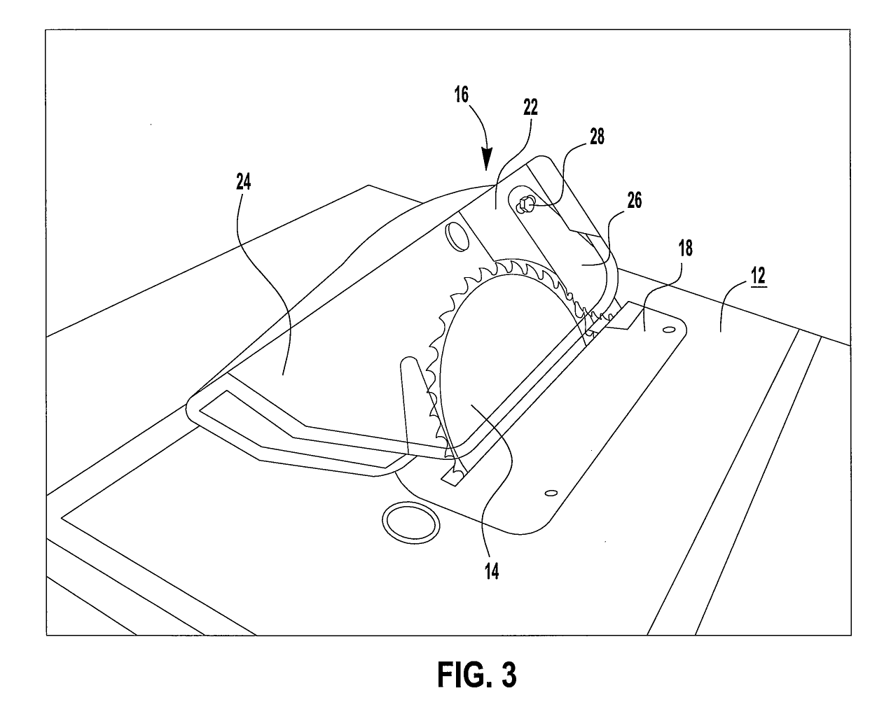

In various embodiments, a saw, such as a table saw, for example, can be configured to cut a workpiece, wherein the workpiece can be comprised of wood, metal, plastic, and/or other materials. In at least one embodiment, the saw can further include at least one saw accessory assembly configured to be attached to the saw, wherein the assembly can be configured to protect an operator from contacting the saw blade, for example. In various embodiments, referring to FIGS. 1-3, saw 10 can include base 11, work surface 12, legs 13, blade 14, fence 15, and saw accessory assembly 16. In at least one embodiment, saw 10 can further include an arbor (not illustrated) configured to rotate blade 14 in a suitable direction. In various embodiments, the arbor can be operably attached to a drive shaft of a motor (not illustrated) such that, when the motor is activated by a power source, the arbor can rotate blade 14. In at least one embodiment, the arbor and motor can be positioned within base 11, for example.

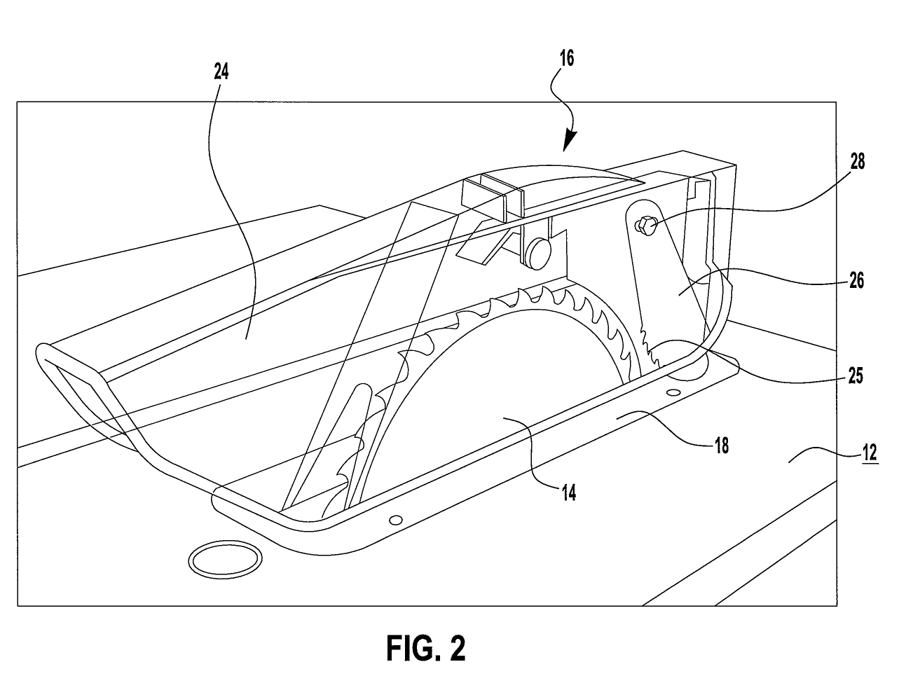

Referring to FIGS. 1 and 2, saw 10 can further include throat plate 18, wherein saw blade 14 can be configured to extend through a slot in throat plate 18 such that saw blade 14 can contact and cut the workpiece. In at least one embodiment, referring to FIGS. 1-3, throat plate 18 can be positioned on, and can be generally flush with, work surface 12, wherein blade 14 can be raised and lowered with respect to throat plate 18 and work surface 12 through the use of hand-screw 20. In such embodiments, blade 14 can be used to cut workpieces having different thicknesses and/or perform various types of cuts. In at least one embodiment, blade 14 and the arbor can be pivoted with respect to throat plate 18 and work surface 12 in order to produce bevel cuts, for example. In various embodiments, the pivoting of blade 14 and the arbor can be accomplished through the use of second hand-screw 21. In other various embodiments, blade 14 can be raised, lowered, and/or pivoted by any other suitable mechanical, hydraulic, pneumatic, and/or electrical devices.

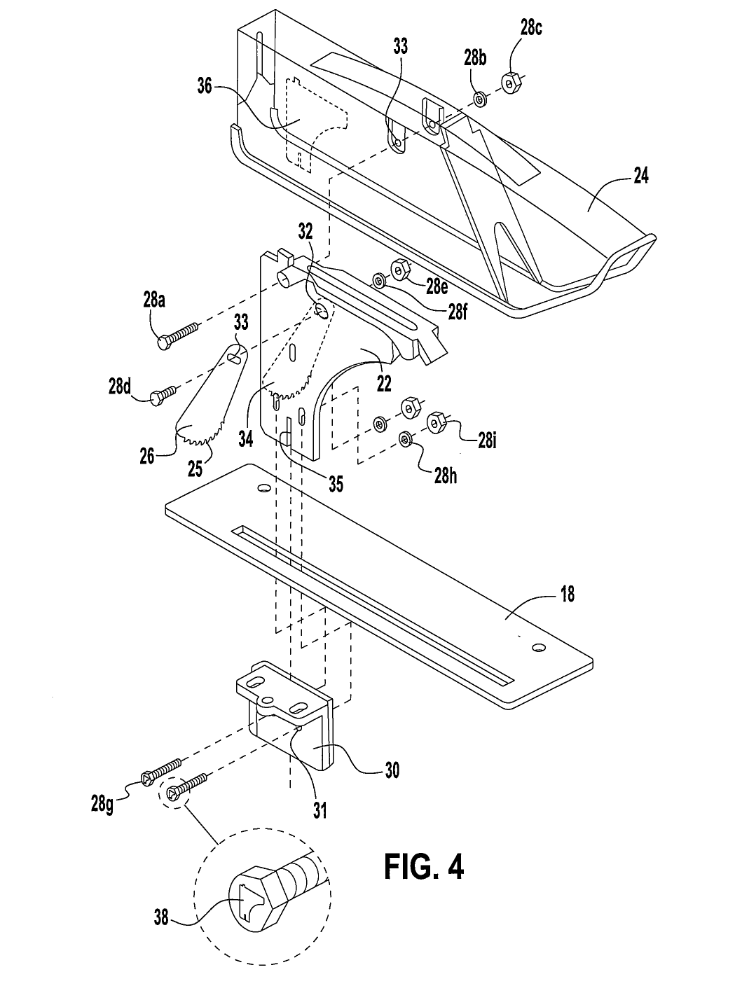

Referring to FIG. 4, a saw accessory assembly can include one or more throat plate 18, riving knife 22, blade guard 24, anti-kickback pawls 26, support 30, connection members 28a-28i, for example, and/or other any suitable saw accessory components. Notably, while a “riving knife” is generally referred to herein, such a term is also meant to include a splitter or a divider as these terms are known in the art. In various embodiments, referring to FIGS. 1-4, riving knife 22 can be rigidly attached to support 30 underneath work surface 12 of saw 10 and can be configured to extend above work surface 12 to engage the workpiece after the workpiece has been cut by blade 14 as outlined above. In various embodiments, support 30 and riving knife 22 can each include one or apertures 31 and 35, respectively, which can be aligned to receive fasteners 28g, washers 28h, and/or nuts 28i, i.e., connection members 28, which can be positioned therethrough to attach riving knife 22 to support 30. In at least one such embodiment, riving knife 22 can be adjusted with respect to work surface 12 or blade 14 by loosening connection members 28, sliding riving knife 22 relative to support 30, and tightening connection members 28 once again. In such circumstances, the adjustability of riving knife 22 can provide the operator with the ability to raise and lower the riving knife to meet the needs of a particular cutting operation.

In various embodiments, another saw accessory assembly component, such as a blade guard, for example, can be attached to a portion of the riving knife and can be situated over the blade of the saw to prevent the operator from contacting the blade. In at least one embodiment, the blade guard, such as blade guard 24, for example, can also be configured to cover or surround riving knife 22 and anti-kickback pawls 26. In various embodiments, referring to FIG. 4, blade guard 24 can be attached to riving knife 22 via at least one aperture 32 in riving knife 22 and at least one aperture 33 in blade guard 24. In such an embodiment, the operator can axially align aperture 32 in riving knife 22 with aperture 33 in blade guard 24 and can then utilize at least one connection member 28 (28a-28c) to attach blade guard 24 to riving knife 22. In various embodiments, as indicated above, connection members 28 can include bolts, threaded rods, screws, pins, springs, washers, and nuts, or any combination of the same, for example. In other various embodiments, connection members 28 can include any other suitable attachment devices such as a clamping member (not illustrated), for example.

In various embodiments, in addition to or in lieu of the above, the saw accessory assembly can include one or more anti-kickback pawls which can be attached to the riving knife and/or the blade guard. In at least one embodiment, anti-kickback pawls 26 can be attached to riving knife 22 where connection members 28 (28d-28f) can be used to attach anti-kickback pawls 26 to riving knife 22. In at least one embodiment, anti-kickback pawls 26 can be rotatably mounted to riving knife 22 such that pawls 26 can rotate about an axis defined by connection member 28d when a workpiece is fed through saw blade 14, wherein pawls 26, and teeth 25 extending therefrom, can also be configured to prevent, or at least inhibit, the rotation thereof when the workpiece is kicked upwardly by saw blade 14, for example.

In various embodiments, an operator may be required to remove, attach, assemble and/or adjust the components of a saw accessory assembly. In some circumstances, especially after the operator removes some components from the assembly, the operator may have difficulty in remembering the manner in which the components are reattached or reassembled onto the saw or saw accessory assembly. Additionally, in some instances, the operator may forget the sequence in which the components can, or should, be adjusted while assembled. In order to resolve these difficulties, in various embodiments, the components of the saw accessory assembly can be visually coded with colors, indicia, and/or other visual guides. In at least one embodiment, at least one visual guide can be configured to assist the operator in attaching the components of the saw accessory assembly to the saw. In at least one such embodiment, a first component can include a first visual guide which can be configured to assist the operator in assembling a first component to a second component, for example. Further to the above, in various embodiments, the second component can include a second visual guide which can cooperate with the first visual guide to likewise assist the operator in assembling the first component to the second component. In still other various embodiments, more than two visual guides can be included on one or more components of the saw accessory assembly.

In various embodiments, visual guides in the form of outlines or profiles of adjacent saw accessory components can be used to assist the operator in aligning the components of the saw accessory assembly. In at least one embodiment, referring to FIG. 4, first visual guide 34 on riving knife 22 can include an outline or profile of pawl 26, for example. In various circumstances, as a result, the operator can easily determine the manner in which pawl 26 should be operably positioned on riving knife 22. Further, in various embodiments, blade guard 24 can include second visual guide 36 which can comprise an outline or profile of riving knife 22, for example, thereby similarly indicating to the operator the manner in which blade guard 24 should be attached to riving knife 22. In at least one embodiment, third visual guide 38 on connection member 28 can include an outline or profile of riving knife 22 to indicate that such a connection member 28 should be utilized to mount riving knife 22, for example.

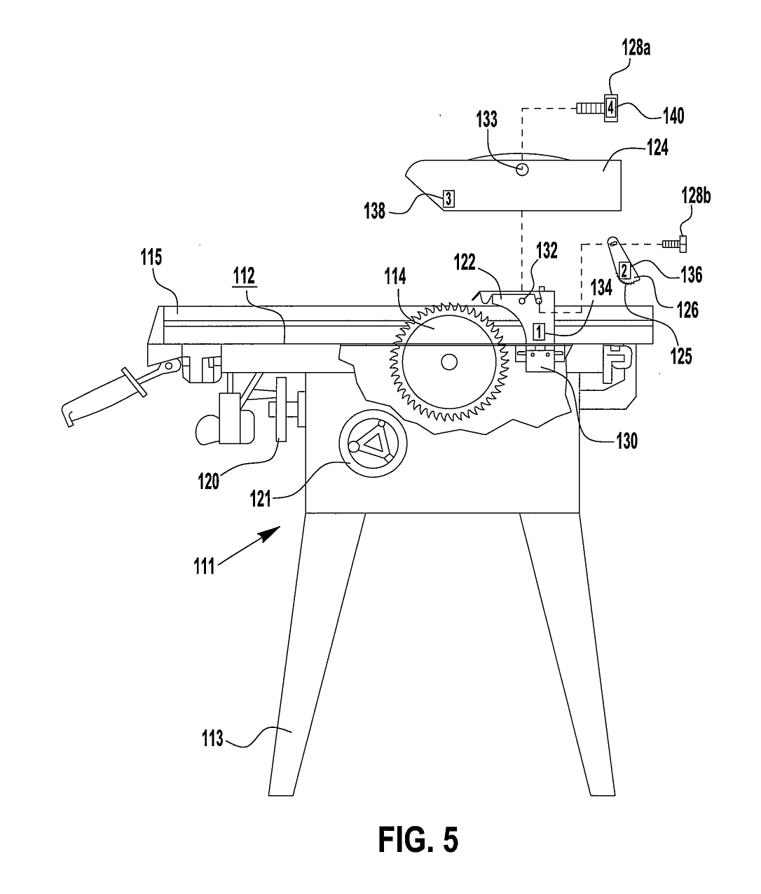

Further to the above, in various embodiments, visual guides in the form of numbering and/or lettering can be used to assist the operator in aligning or configuring the components on the saw accessory assembly. In at least one embodiment, referring to FIG. 5, first visual guide 134 on riving knife 122 can include a number “1”, or letter “A” (not illustrated), second visual guide 136 on pawl 126 can include a number “2”, or letter “B” (not illustrated), third visual guide 138 on blade guard 124 can include a number “3”, or letter “C” (not illustrated), and fourth visual guide 140 on connection member 128a can include a number “4”, or letter “D” (not illustrated), for example. In various embodiments, as a result of the above, the operator can easily determine the manner in which to assemble the components of the saw accessory assembly by simply following the numerical or alphabetical order of the visual guides. In various embodiments, the slots or apertures in the riving knife, blade guard, and/or anti-kickback pawl, for example, can include a number or letter proximate thereto which can indicate to the operator that the connection member demarcated with a “1”, for example, should be inserted through the aperture also demarcated with a “1”. Stated another way, the connection members can include a number, letter, or other indicia matching the numbers, letters or indicia proximate to the slots or apertures. In this fashion, as a result, the operator can easily match the proper connection member with the proper slot or aperture while assembling the components.

In various embodiments, the visual guides on the components of the saw accessory assembly can be color-coded with two or more different colors, different shades of the same color, different intensities of the same color, or a combination thereof. In at least one embodiment, a first visual guide on a first component can include a first color and a second visual guide on a second component can include a second color. In at least one embodiment, a color-coding scheme can be set up to follow the colors of increasing wavelength, for example, such that a component with a red visual guide would first be attached to a component with an orange visual guide. In various embodiments, the components with the red and orange visual guides could next be attached to a component with a yellow visual guide and so forth consecutively through the spectrum of colors.

In various embodiments, the first color on the first visual guide can be substantially the same as the second color on the second visual guide such that the operator can easily match the colors to assemble the components, for example. In other various embodiments, the first color on the first visual guide can have a different shade and/or intensity of the first color than the first color on the second visual guide. Again, here, in various embodiments, the variation of color shade and/or color intensity can allow the operator to intuitively and easily match the components as they assemble the components. For example, the different shades, or intensities, of the same color can indicate to the operator that the components having the darkest-shaded visual guides should be assembled first followed by the components having increasingly lighter-shaded visual guides, for example. Stated another way, a saw accessory component with a visual guide having a first shade and/or intensity of a first color may be attached to a component having a second shade and/or intensity of the first color. As an example of such an embodiment, a first visual guide can include a first intensity of blue while a second visual guide can include a second intensity of blue, for example. In other various embodiments, although not illustrated, a connection member can have a first shade of blue while another component can have the same or a different shade of blue. In various embodiments, as a result, the different shades and/or intensities can be configured to assist the operator in attaching the components. In still other various embodiments, the first and second components can have opposite colors such that the operator can match the opposite colors while attaching the components. In at least one embodiment, a white visual guide can be matched with a black visual guide, or a yellow visual guide can be matched with a blue visual guide, for example. In other various embodiments, any suitable color-coding and/or color matching scheme can be used to assist the operator in the assembly of the components to the saw.

In at least one embodiment, tools such as a wrench, pliers, a screw-driver, a ratchet and socket, or other suitable tool can be used for to engage and/or motivate the connection members, for example. In various embodiments, visual guides may also be located on the tools used to engage and/or motivate the connection members such that the operator can easily match the proper tools with the connection members while assembling the components.

In various embodiments, in addition to or in lieu of the visual guides described above, the saw accessory assembly components can include other suitable indicia including hash markings, arrows, patterns, shapes, stripes, shadowing, for example, which can be configured to assist the operator. Furthermore, in addition to or in lieu of the above, at least one of the components of the saw accessory assembly can include non-visual indicia, such as tactile guides, for example. In various embodiments, a first tactile guide, such as a roughened surface, for example, can be situated on a first component and a second tactile guide can be situated on a second component, for example. In at least one embodiment, the first tactile guide can include a first surface texture and the second tactile guide can include a second surface texture such that the operator can match the surface textures of the first and second tactile guides while assembling the first and second components. In various embodiments, the tactile guides can include ridges, rough surfaces, and/or detents, for example, and/or any other suitable type of tactile guide.

After assembling the components of the saw accessory assembly, as described above, the operator may often be required to determine the proper sequence in which to adjust the components in order to ensure that the components function properly and/or provide adequate protection to the operator. For example, a riving knife may be adjusted in the vertical, horizontal, forward, and/or rearwards directions with respect to the blade and, likewise, a blade guard may be adjusted from a position proximate to the blade to position remote from the blade. In addition, the blade guard may also be moved in the vertical direction with respect to the work surface of the saw to accommodate a particular workpiece and/or saw blade. Furthermore, the pawls may be adjusted in the vertical, horizontal, forward, and/or rearwards directions to, again, accommodate a particular workpiece and/or saw blade. In various embodiments, the operator should adjust, or may be required to adjust, these components in a predetermined sequence.

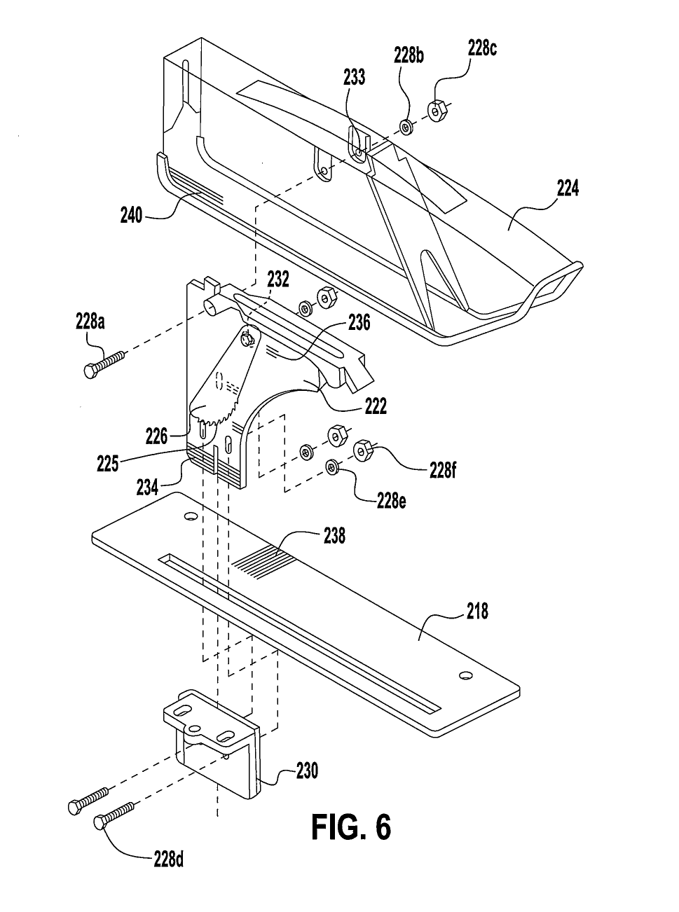

In various embodiments, in order to provide the operator with the predetermined sequence of adjusting components, the components of the saw accessory assembly can include at least one visual adjustment guide on at least one of the components. In at least one embodiment, similar to the above, the visual adjustment guides can utilize one or more of the visual and/or tactile guides described above, including color-coding, for example. In various embodiments, referring to FIG. 6, first visual adjustment guide 234 can be situated on riving knife 222, second visual adjustment guide 236 can be situated on riving knife 222, third visual adjustment guide 238 can be situated on throat plate 218, and fourth visual adjustment guide 240 can be situated on blade guard 224, wherein visual adjustment guides 234, 236, 238, and 240 can assist the operator in adjusting the components to suit a particular cutting operation.

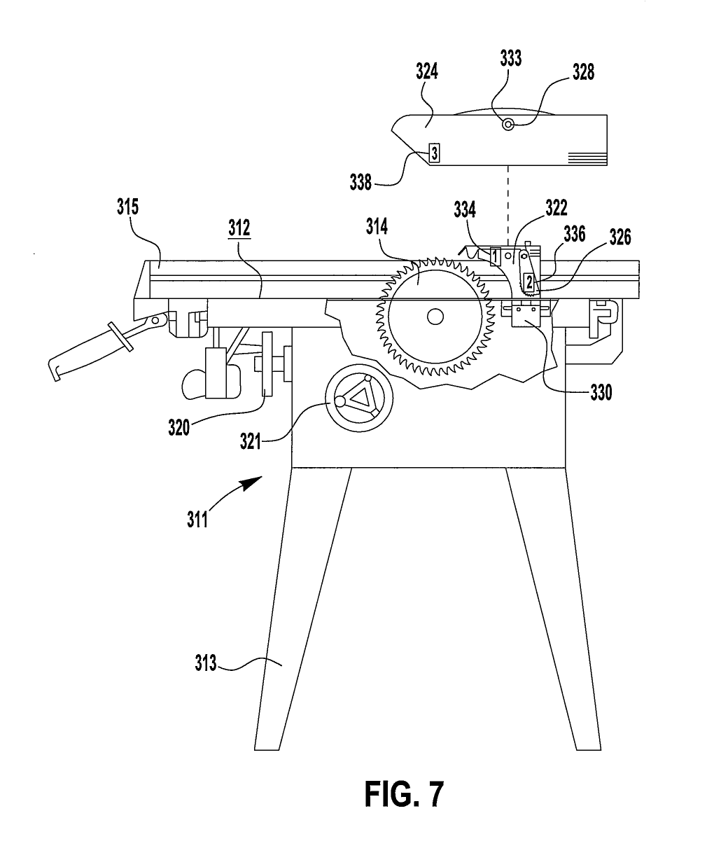

In various embodiments, further to the above and referring to FIG. 7, first visual adjustment guide 334 can include a number “1” on riving knife 322, second visual adjustment guide 336 can include a number “2” on anti-kickback pawl 326, and third visual adjustment guide 338 including a number “3” on blade guard 324, for example, wherein such indicia can communicate to the operator that riving knife 322 should be adjust first, pawls 326 second, and blade guard 324 last. In at least one embodiment, although not illustrated, riving knife 322 can include a red visual adjustment guide, pawl 326 can include an orange visual adjustment guide, and blade guard 324 can include a yellow visual adjustment guide, for example. In such an embodiment, by following the spectrum of colors in the rainbow as discussed above, the operator can easily determine that riving knife 322 should be adjusted first and that blade guard 324 should be adjusted last.

In various embodiments, in order to further assist the operator, a saw, and/or the saw accessory assembly, can include a color-code chart, for example, which can more expressly describe to the operator the order and manner in which the saw accessory components are to be assembled and/or adjusted.

While the present invention has been described with reference to a saw, namely a table saw, those skilled in the art will recognize that, in various embodiments, the visual guides and the visual adjustment guides can be applied to any type of saw accessory on any suitable type of saw or cutting machine. Furthermore, while this invention has been described as having exemplary designs, the present invention may be further modified within the spirit and scope of the disclosure. This application is therefore intended to cover any variations, uses, or adaptations of the invention using its general principles. Further, this application is intended to cover such departures from the present disclosure as come within known or customary practice in the art to which this invention pertains.

1. A saw accessory assembly configured to be attached to a saw, the saw accessory assembly comprising:
a first component including one of a riving knife, a throat plate, a blade guard, an anti-kickback pawl, and a connection member; and
a second component including one of a riving knife, a throat plate, a blade guard, an anti-kickback pawl, and a connection member, wherein said first component includes a first visual guide configured to assist an operator in assembling said first component to said second component.

2. The saw accessory assembly of claim 1, wherein said second component further comprises a second visual guide configured to assist the operator in assembling said first component to said second component.

3. The saw accessory assembly of claim 2, wherein said first visual guide includes a first color, wherein said second visual guide includes a second color, and wherein said first color is different than said second color.

4. The saw accessory assembly of claim 2, wherein said first visual guide includes a first color, wherein said second visual guide includes said first color, and wherein said first color of said first and second visual guides is configured to assist the operator in assembling said first component to said second component.

5. The saw accessory assembly of claim 4, wherein said first color of said first visual guide includes a first shade of said first color, wherein said first color of said second visual guide includes a second shade of said first color, and wherein said first shade is different than said second shade.

6. The saw accessory assembly of claim 4, wherein said first color of said first visual guide includes a first intensity of said first color, wherein said first color of said second visual guide includes a second intensity of said first color, and wherein said first intensity is different than said second intensity.

7. The saw accessory assembly of claim 2, wherein at least a portion of said first visual guide is comprised of a first surface texture, wherein at least a portion of said second visual guide is comprised of a second surface texture, and wherein said first and second surface textures are configured to assist the operator in assembling said first component to said second component.

8. The saw accessory assembly of claim 2, further comprising a third component including one of a riving knife, a throat plate, an anti-kickback pawl, and a connection member, wherein said third component includes a third visual guide, and wherein said first, second, and third visual guides are configured to assist the operator in assembling said first, second, and third components.

9. The saw accessory assembly of claim 2, wherein said first visual guide includes a first indicium, wherein said second visual guide includes a second indicium, and wherein said first indicium is different than said second indicium.

10. The saw accessory assembly of claim 1, wherein said first visual guide includes an outline of said second component to assist the operator in assembling said first component to said second component.

11. A saw accessory assembly configured to be attached to a saw, the saw accessory assembly comprising:
a first component including one of a riving knife, a throat plate, a blade guard, an anti-kickback pawl, and a connection member; and
a second component including one of a riving knife, a throat plate, a blade guard, an anti-kickback pawl, and a connection member, wherein at least one of said first and second components includes a visual guide means for assisting an operator in assembling said first component to said second component.

12. A saw accessory assembly configured to be attached to a saw, the saw accessory assembly comprising:
a first component including one of a riving knife, a throat plate, an anti-kickback pawl, a blade guard, and a connection member, wherein said first component includes a first visual adjustment guide; and
a second component including one of a riving knife, a throat plate, an anti-kickback pawl, a blade guard, and a connection member, wherein said second component includes a second visual adjustment guide, and wherein said first and second visual adjustment guides are configured to assist an operator in adjusting said first and second components in a predetermined sequence.

13. The saw accessory assembly of claim 12, wherein said first visual adjustment guide includes a first color, and wherein said second visual adjustment guide includes a second color.

14. The saw accessory assembly of claim 12, wherein said first visual adjustment guide includes a first color, wherein said second visual adjustment guide includes said first color, and wherein said first color of said first and second visual adjustment guides is configured to assist the operator in adjusting said first and second components in the predetermined sequence.

15. The saw accessory assembly of claim 12, wherein said first color of said first visual adjustment guide includes a first shade of said first color, wherein said first color of said second visual adjustment guide includes a second shade of said first color, and wherein said first shade is different than said second shade.

16. The saw accessory assembly of claim 12, wherein said first color of said first visual adjustment guide includes a first intensity of said first color, wherein said first color of said second visual adjustment guide includes a second intensity of said first color, and wherein said first intensity is different than said second intensity.

17. The saw accessory assembly of claim 12, wherein said first visual adjustment guide includes a first indicium, and wherein said second visual adjustment guide includes a second indicium.

18-20. (canceled)
